(19) United States
(12) Patent Application Publication
(10) Pub. No.: US 2006/0117638 A1
(43) Pub. Date: Jun. 8, 2006

(54) Audio video indicator for fishing

(76) Inventor: Sang Chul Park, Brooklyn, NY (US)

Correspondence Address: PARK LAW FIRM, 3255 WILSHIRE BLVD, SUITE 1110, LOS ANGELES, CA, 90010, US

(21) Appl. No.: 11/004,268

(22) Filed: Dec. 3, 2004

(51) Int. Cl. A01K 97/12

(52) U.S. Cl. 43/17

(57) ABSTRACT

An indicator for fishing includes a detecting device for detecting the physical property of fishing line, an audio indicating device to alert an angler with sound, and a video indicator to alert the angler with light, according to the change of the physical property of the fishing line. The detecting device can detect the moment of a fish's striking a bait by detecting the tension of the fishing line or the temporal change of the tension of the fishing line held by the fishing line holder. The indicator further includes a fishing rod holder, a fishing line holder, and an illuminating device. The audio indicating device includes a sound producing device and signals the fish's striking by producing a predetermined sound. The video indicating device includes a first lighting device producing a light of a predetermined color, and a second lighting device producing a light of other predetermined color.

### BACKGROUND OF THE INVENTION

This invention is related to an audio video indicator for fishing, which helps anglers to know the right time to reel in the fishing line. More particularly, the invention is related to an audio video indicator for fishing that enables the anglers with limited sensing capability to enjoy fishing. The invention is also related to a device that can be attached to a regular fishing rod and improves the performance of the fishing rod significantly in catching the right moment to reel in and handling the fishing tools at night.

Fishing has a long history. In the early stage of human history before the development of agriculture, which is called the hunter-gatherer society, fishing was one of major activities of humankind for the survival itself. Some excavated fishing hook was dated back to time period thousands of years ago, the Stone Age.

Humanity had passed the stage of fishing and hunting for survival long time ago. The introduction of agriculture had reduced the importance of fishing and hunting drastically and the rather recent technological development of agricultural technique called green revolution has exterminated the fishing in the level of individuals as means of survival almost to nil. Fishing itself, however, survived all the era of change and innovation.

Recreational fishing is still popular ever since around the world. Tens of thousands of people go fishing out to creek, river, lake, and seashore in America in weekends and holidays.

The equipment for fishing, especially of angling, has been changed very little through the history. The fishing hook is made of stainless steel, not of bone, with a sharp point, and the fishing line is made of a strong nylon fiber, not of natural fiber extracted from plant or animal any more. For example, however, the shape of the hook remains strikingly same.

The equipment for angling includes a fishing rod, a fishing line, a fishing hook, and some improving accessories such as bobber, bell, reel, and rod stand.

Fishing consists of the steps of choosing a fishing spot, dipping the bait-put fishing hook in water, waiting the fish to bite, and reeling in at the right moment.

To many anglers, conventionally, the trickiest step is recognizing the right moment to reel in. The fish is not seen from above the surface of water in most cases. Therefore, the anglers use their hands to feel the jerking movement of the fishing rod or their ears to listen to the fishing bell attached to the fishing line which rings with the vibration of the rod.

With these kinds of traditional methods, firstly, it is not easy to catch the moment in real situations stricken with wind or noise, and secondly, the traditional methods are useless to the anglers with impaired senses, totally blocking the individuals with impaired senses from enjoying the angling.

Accordingly, a need for the audio video indicator for fishing has been worldwide for quite a long time. This invention is directed to solve these problems and satisfy the long-felt need.

### SUMMARY OF THE INVENTION

An object of the invention is to provide an audio video indicator for fishing rod having a fishing line, which helps anglers to know the right time to reel in the fishing line.

Another object of the invention is to an audio video indicator for fishing that enables the anglers with limited sensing capability to enjoy fishing.

Still other object of the invention is to provide an audio video indicator for fishing that can be attached to a regular fishing rod and improves the performance of the fishing rod significantly in catching the right moment to reel in and handling the fishing tools at night.

The audio video indicator for fishing rod having a fishing line include a detecting device for detecting change of a physical property of the fishing line and an indicating device to alert an angler with a signal to the human perception organs in response to the change of the physical property of the fishing line with sound detected by the detecting device.

The detecting device detects the tension of the fishing line or the temporal change of the tension of the fishing line and the signal from the indicating device can be an audio signal, a video signal, or an audio signal and video signal.

The audio indicating device includes a sound producing device, which signals the fish's striking of the bait by producing a predetermined sound.

The video indicating device includes a first lighting device producing a light of a predetermined color, and a second lighting device producing a light of other predetermined color. The first lighting device is on and the second lighting device is off when the fish does not strike the bait, and the first lighting device is off and the second lighting device is on when the fish strikes the bait. The lighting device includes an LED (light-emitting diode) producing a light of a predetermined color. The first lighting device includes a green LED and the second lighting device includes a red LED. The red LED can blink when the fish strikes the bait in order to emphasize the alert.

The audio video indicator for fishing further includes a fishing line holder, which is connected to the detecting device, transferring the change of tension of the fishing line to the detecting device. The fishing line holder includes a clip made of material with large frictional constant.

The audio video indicator for fishing also includes a fishing rod holder and the fishing rod holder includes a mechanical fastener, which is adjustable according to fishing rods of different sizes.

The audio video indicator further includes an illuminating device, which includes a light source and a mounting device. The mounting device can change the position of the light source with respect to the audio video indicator.

The fishing line from the reeled end is extended through the fishing line holder.

The detecting device detects the tension of the fishing line or the temporal change of the tension of the fishing line held by the fishing line holder, and provides electrical signals to the audio indicator and the video indicator according to the detected physical property of the fishing rod.

The audio video indicator for fishing further includes an electrical switch disabling the sound from the audio indicating device selectively.

Many other innovations, features, and advantages will be evident with the following description of the invention.

### BRIEF DESCRIPTION OF THE DRAWINGS

These and other features, aspects and advantages of the present invention will become better understood with reference to the accompanying drawings, wherein:

FIG. 1 is a schematic perspective view of an audio video indicator according to the invention installed on a fishing rod;

FIG. 2 is a plan view of an audio video indicator; and

FIG. 3 is a schematic block diagram showing a detecting device and indicating devices.

### DETAILED DESCRIPTION OF THE INVENTION

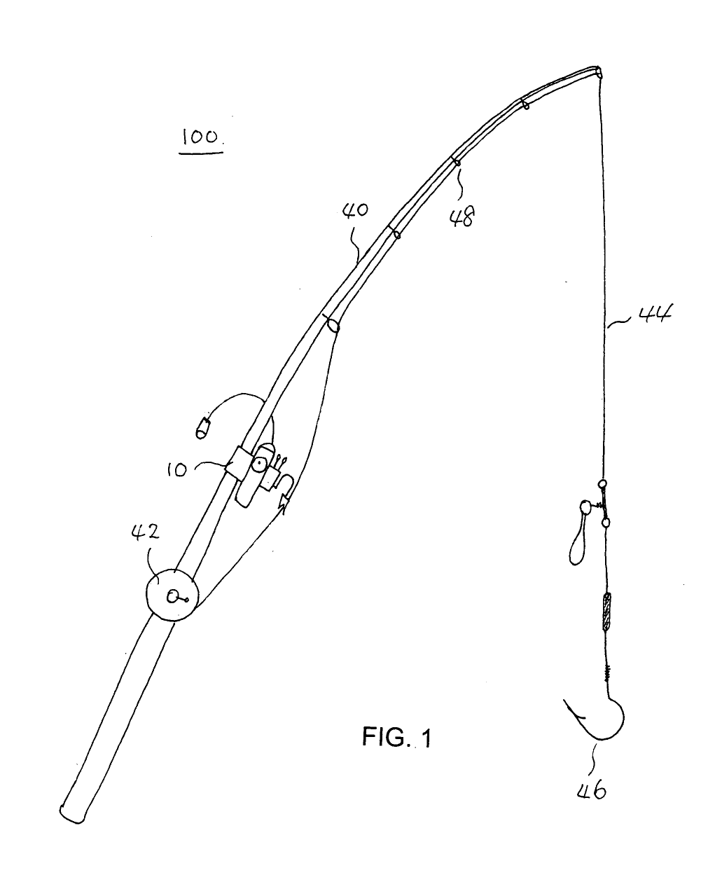

FIG. 1 shows a schematic perspective view of an audio video indicator 10 for fishing installed on a fishing rod 20 which includes a reel 42, a fishing line 44, a fishing hook, and a plurality of rings 48 for fishing line 44.

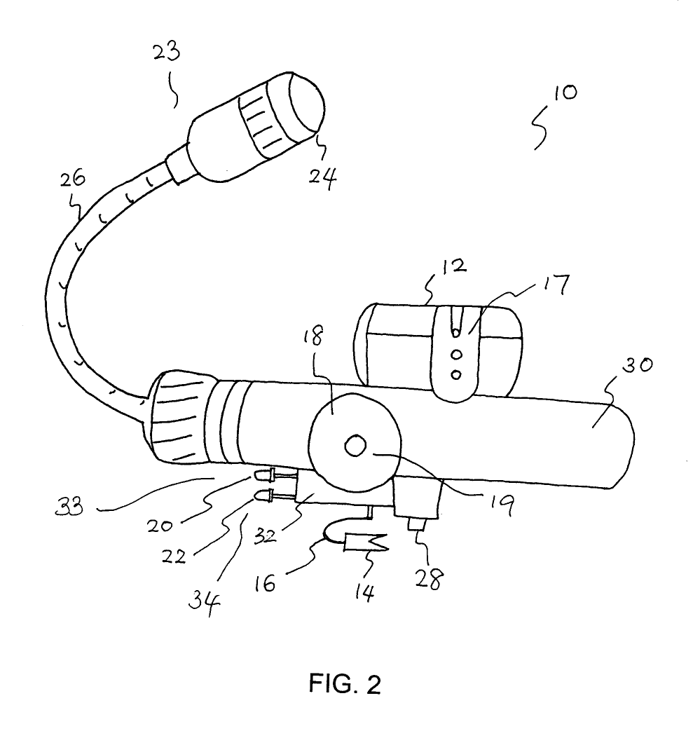

FIG. 2 shows a plan view of the audio video indicator 10 for fishing.

The audio video indicator 10 for fishing rod 40 having a fishing line 44 includes a detecting device 16 for detecting change of a physical property of the fishing line and an indicating devices 33 to alert an angler with a signal to the human perception organs in response to the change of the physical property of the fishing line 44 detected by the detecting device 16.

The detecting device 16 detects the tension of the fishing line 44 or the temporal change of the tension of the fishing line 44 and the signal from the indicating device 33 can be an audio signal, a video signal, or an audio signal and video signal.

The detecting device 33 is connected to the fishing line holder 14 and an electrical circuit 32 is connected with the audio indicating device 18 and the video indicating device 20, 22, providing a predetermined electrical signal for the audio indicating device 18 and the video indicating device 20, 22 in response to whether the fish strikes the bait on the fishing hook 46.

When a fish strikes the bait, the tension of the fishing line 44 increases up to the point to create a mechanical displacement of the detecting device 16 closing an electrical contact. The electrical contact makes the electrical circuit 32 to produce the electrical signals for the audio indicating device 18 and the video indicating device 20, 22.

The audio indicating device 18 includes a sound producing device 19, which signals the fish's striking of the bait by producing a predetermined sound. The sound producing device 19 includes a melody chip and a speaker.

The video indicating device 34 includes a first lighting device 20 producing a light of a predetermined color, and a second lighting device 22 producing a light of other predetermined color. The first lighting device 20 is on and the second lighting device 22 is off when the fish does not strike the bait, and the first lighting device 20 is off and the second lighting device 22 is on when the fish strikes the bait. The lighting device 20, 22 includes an LED (light-emitting diode) producing a light of a predetermined color. The first lighting device 20 includes a green LED and the second lighting device 22 includes a red LED. The red LED can blink when the fish strikes the bait in order to emphasize the alert.

The audio video indicator for fishing 10 further includes a fishing line holder 14, which is connected to the detecting device 16, transferring the change of tension of the fishing line to the detecting device 16. The fishing line holder 14 includes a clip made of material with large frictional constant. Also, the fishing line holder 14 may include a spring clip that accepts the fishing line 44 and does not release unless a force greater than a predetermined magnitude is applied.

The audio video indicator 10 for fishing also includes a fishing rod holder 12 and the fishing rod holder 12 includes a mechanical fastener 17, which is adjustable according to fishing rods 20 of different sizes.

The audio video indicator 10 further includes an illuminating device 23, which includes a light source 24 and a mounting device 26. The mounting device 26 can change the position of the light source 24 with respect to the audio video indicator 10.

The fishing line 44 from the reeled end is extended through the fishing line holder 14, rings 48 provided on the fishing rod 40, and finally to the fishing hook 46 at the open end.

The detecting device 16 detects the tension of the fishing line 44 or the temporal change of the tension of the fishing line 44 held by the fishing line holder 14, and provides electrical signals to the audio indicating device 18 and the video indicating device 20, 22 according to the detected physical property of the fishing rod 40.

The audio video indicator 10 for fishing further includes an electrical switch 28 disabling the sound from the audio indicating device 18 selectively in order not to disturb other anglers or fish.

The audio video indicator 10 for fishing further includes an electrical power source 30 for the detecting device 16, the audio indicating device 18, the video indicating device 20, 22, and the illuminating device 24. The power source is preferably a battery box.

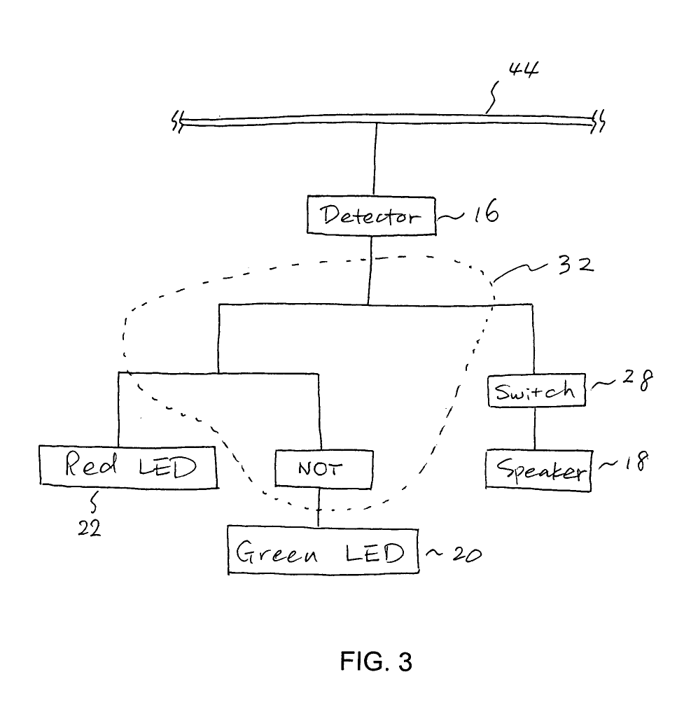

FIG. 3 shows a schematic block diagram showing the detecting device 16 and indicators 18, 20, 22.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. An indicator for fishing rod having a fishing line, comprising:
a) a detecting device for detecting change of a physical property of the fishing line; and
b) an indicating device to alert an angler with a signal to the human perception organs in response to the change of the physical property of the fishing line detected by the detecting device.

2. The indicator of claim 1, wherein the detecting device detects the tension of the fishing line or the temporal change of the tension of the fishing line.

3. The indicator of claim 1, wherein the signal is an audio signal.

4. The indicator of claim 3, wherein the signal is a video signal.

5. The indicator of claim 3, wherein the signal is an audio signal and a video signal.

6. The indicator of claim 1, wherein the audio indicating device comprises a sound producing device.

7. The indicator of claim 6, wherein the audio indicating device signals the fish's striking of the bait by producing a predetermined sound.

8. The indicator of claim 6, wherein the video indicating device comprises a first lighting device producing a light of a predetermined color, and a second lighting device producing a light of other predetermined color.

9. The indicator of claim 8, wherein the first lighting device is on and the second lighting device is off when the fish does not strike the bait, and the first lighting device is off and the second lighting device is on when the fish strikes the bait.

10. The indicator of claim 8, wherein the lighting device comprises an LED (light-emitting diode) producing a light of a predetermined color.

11. The indicator of claim 10, wherein the first lighting device comprises a green LED and the second lighting device comprises a red LED.

12. The indicator of claim 11, wherein the red LED blinks when the fish strikes the bait.

13. The indicator of claim 1 further comprising a fishing line holder.

14. The indicator of claim 13 further comprising a fishing rod holder, wherein the fishing rod holder comprises a mechanical fastener which is adjustable according to fishing rods of different sizes.

15. The indicator of claim 13, wherein the fishing line holder comprises a clip.

16. The indicator of claim 15, wherein the clip is made of material with large frictional constant.

17. The indicator of claim 15, wherein the clip comprises a spring clip that accepts the fishing line and does not release unless a force greater than a predetermined magnitude is applied.

18. The indicator of claim 13 further comprising an illuminating device, wherein the illuminating device comprises a light source and a mounting device.

19. The indicator of claim 18, wherein the mounting device can change the position of the light source with respect to the audio video indicator.

20. The indicator of claim 13, the fishing line from the reeled end is extended through the fishing line holder.

21. The indicator of claim 20, wherein the detecting device detects the tension of the fishing line or the temporal change of the tension of the fishing line held by the fishing line holder.

22. The indicator of claim 21, the detecting device provides electrical signals to the audio indicating device and the video indicating device according to the detected physical property of the fishing rod.

23. The indicator according to claim 1, wherein the indicating device further comprises an electrical switch disabling the sound selectively.
